(19) United States
(12) Patent Application Publication
(10) Pub. No.: US 2011/0145865 A1
(43) Pub. Date: Jun. 16, 2011

(54) PERSONAL CHANNEL PREFERENCES FOR MULTIMEDIA PROGRAMS

(75) Inventor: Anita Hogans Simpson, Decatur, GA (US)

(73) Assignee: AT&T Intellectual Property I, L.P., Reno, NV (US)

(21) Appl. No.: 12/638,574

(22) Filed: Dec. 15, 2009

(51) Int. Cl. H04N 5/445

(52) U.S. Cl. 725/46

(57) ABSTRACT

A method and system for enabling Internet-protocol television (IPTV) users to maintain personal channel lists is configured to receive user input via an access network. The access network may comprise portions of an IPTV network, a public network, an Internet network, and/or a wireless network. A request from an IPTV user may be received for accessing/creating a personal channel list specific to the IPTV user. Input from the IPTV user may further be received to add IPTV channel identifiers to the personal channel list. IPTV user input may then be received to perform operations for maintaining the personal channel list. The IPTV user may optionally specify a security element for restricting access to the personal channel list.

### BACKGROUND

1. Field of the Disclosure

The present disclosure relates to Internet-protocol television (IPTV) and, more particularly, to personal IPTV channel preferences for IPTV users.

2. Description of the Related Art

IPTV content broadcast to a multitude of IPTV users may include previews and related information for selected IPTV channels. The selected IPTV channels offered for preview may be based on a generalized category for all IPTV users.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 is a block diagram of selected elements of an embodiment of an IPTV network;

FIG. 5 illustrates an embodiment of a method for maintaining personal channel lists in an IPTV network; and

FIG. 6 illustrates an embodiment of a method for maintaining personal channel lists in an IPTV network.

### DESCRIPTION OF THE EXEMPLARY EMBODIMENTS

In one aspect, a disclosed method for maintaining personal IPTV channel lists includes receiving, via an access network, a request from an IPTV user to generate a personal channel list of IPTV channels, the personal channel list being specific to the IPTV user. In response to receiving first input from the IPTV user, the method may further include creating the personal channel list for the IPTV user. In response to receiving second input from the IPTV user, the method may further include associating the second input with a corresponding IPTV channel to include in the personal channel list. The method may still further include inserting an identifier for the IPTV channel in the personal channel list, and displaying an indication to the IPTV user of IPTV channels included in the personal channel list.

In specific embodiments, the method may further include storing information describing the personal channel list at a database server. The information may be indexed to the IPTV user. The database server may include personal channel list information indexed to a plurality of IPTV users. The access network may include a portion of at least one of: an IPTV network, a public network, an Internet network, and a wireless network. The personal channel list information may be accessible from at least one of: any of a plurality of customer premises equipment and a mobile device.

In particular embodiments, the method also includes, in response to receiving the request, authenticating an identity of the IPTV user based on an IPTV network account for the IPTV user. In response to receiving third user input from the IPTV user, the method may further include assigning a list name to the personal channel list. In response to receiving fourth user input from the IPTV user, the method may also include assigning a security element for restricting access to the personal channel list.

In given embodiments, the displayed indication may further include a video preview of content currently being transmitted to IPTV channels in the personal channel list, and/or schedule information for IPTV channels in the personal channel list.

In a further aspect, a disclosed computer system for enabling IPTV users to access personal channel lists may include a processor configured to access memory media. The memory media may include instructions executable by the processor to receive, via an access network, a request from an IPTV user to access a personal channel list of IPTV channels, the personal channel list being specific to the IPTV user, and cause an indication to be displayed to the IPTV user of IPTV channels included in the personal channel list.

In one embodiment, the memory media may further include processor-executable instructions to create the personal channel list for the IPTV user in response to receiving first input from the IPTV user, and associate second input with a corresponding IPTV channel to include in the personal channel list in response to receiving the second input from the IPTV user. The memory media may still further include processor-executable instructions to store an identifier for the selected IPTV channel in the personal channel list.

In various embodiments, the memory media may further include processor-executable instructions to display a selected IPTV channel for viewing in response to receiving third input from the IPTV user selecting the IPTV channel included in the personal channel list. In response to receiving fourth input from the IPTV user, the memory media may further include processor-executable instructions to modify the personal channel list, including processor instructions to execute at least one of: add an IPTV channel identifier to the personal channel list, remove an IPTV channel identifier from the personal channel list, rename the personal channel list, rename an IPTV channel identifier included in the personal channel list, and delete the personal channel list. The memory media may still further include processor executable instructions to authenticate an identity of the IPTV user in response to receiving the request, and store information describing the personal channel list in a database indexed to the IPTV user identity. The database may include personal channel list information indexed to a plurality of IPTV users. The access network may include a portion of at least one of: an IPTV network, a public network, an Internet network, and a wireless network, and wherein said displayed indication is sent to the IPTV user via the access network.

In yet another aspect, a disclosed computer-readable memory media includes executable instructions for enabling IPTV users to maintain personal channel lists. The instructions may be executable to receive, via an access network, a request from an IPTV user to access a personal channel list of IPTV channels, the personal channel list being specific to the IPTV user. The instructions may further be executable to send to the IPTV user, via the access network, an indication of IPTV channels included in the personal channel list.

In particular embodiments, the memory media may further include instructions executable to create the personal channel list for the IPTV user in response to receiving first input from the IPTV user, and select an IPTV channel to include in the personal channel list in response to receiving second input from the IPTV user. The memory media may further include instructions executable to store an identifier for the selected IPTV channel in the personal channel list. The memory media may further include instructions executable to, in response to receiving the request, authenticate an identity of the IPTV user, and store information describing the personal channel list in a database indexed to the IPTV user identity. The database may include personal channel list information indexed to a plurality of IPTV users. The access network may include a portion of at least one of: an IPTV network, a public network, an Internet network, and a wireless network.

In certain embodiments, the memory media may further include instructions executable to modify the personal channel list in response to receiving first input from the IPTV user. The instructions executable to modify may include instructions to execute at least one of: add an IPTV channel identifier to the personal channel list, remove an IPTV channel identifier from the personal channel list, delete the personal channel list, assign a security element for restricting access to the personal channel list, assign a list name to the personal channel list, rename the personal channel list, and rename an IPTV channel identifier. The memory media may also include instructions executable to display the selected IPTV channel for viewing in response to receiving second input from the IPTV user selecting an IPTV channel included in the personal channel list. The indication sent to the IPTV user may further include a video preview of content currently being transmitted on the IPTV channels in the personal channel list, and schedule information for IPTV channels in the personal channel list.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

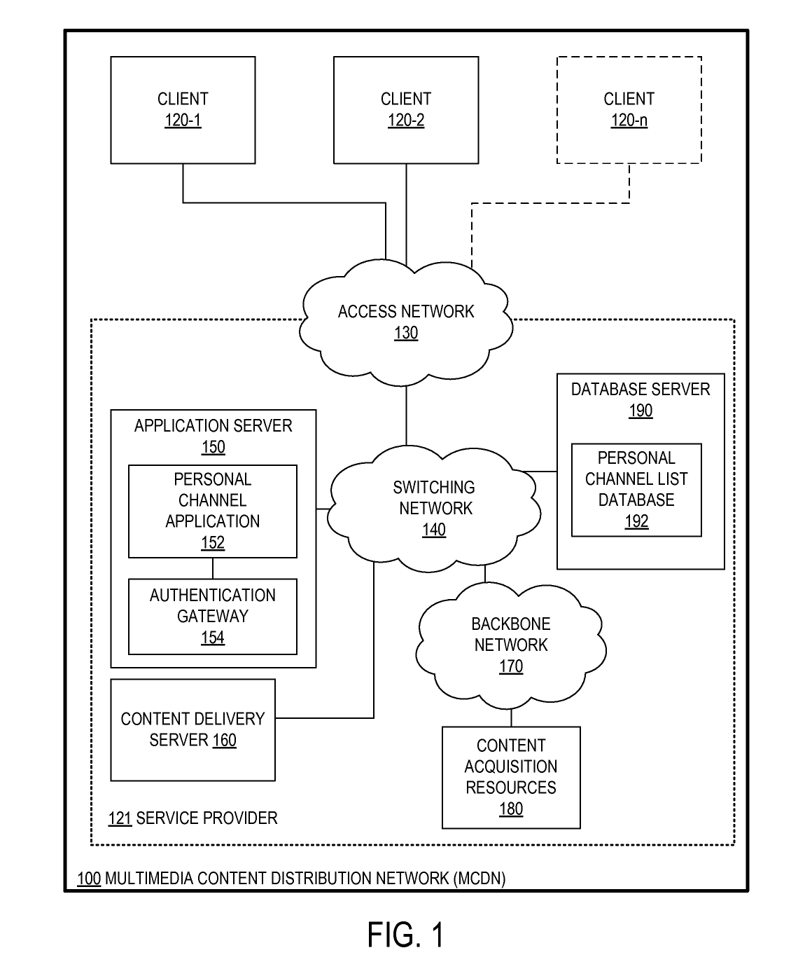

Turning now to the drawings, FIG. 1 is a block diagram illustrating selected elements of an embodiment of multimedia content distribution network (MCDN) 100. Although multimedia content is not limited to TV, video on demand (VOD), or pay-per-view (PPV) programs, the depicted embodiments of MCDN 100 and its capabilities are primarily described herein with reference to these types of multimedia content, which are interchangeably referred to herein as “multimedia content”, “multimedia content programs”, “multimedia programs”, “IPTV programs”, “IPTV channels”, or, simply, “programs.” It is noted that MCDN 100 may be referred to as an “IPTV network.”

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twisted pair cables, fiber optic cables, or a combination thereof. MCDN 100 may include digital subscriber line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Backbone network 170 may provide multimedia content over large geographic areas, such as between major population centers, or across an entire national network system. Content acquisition resources 180 as depicted in FIG. 1 encompass the acquisition of various types of content including broadcast content, other “live” content including national content feeds, and VOD content.

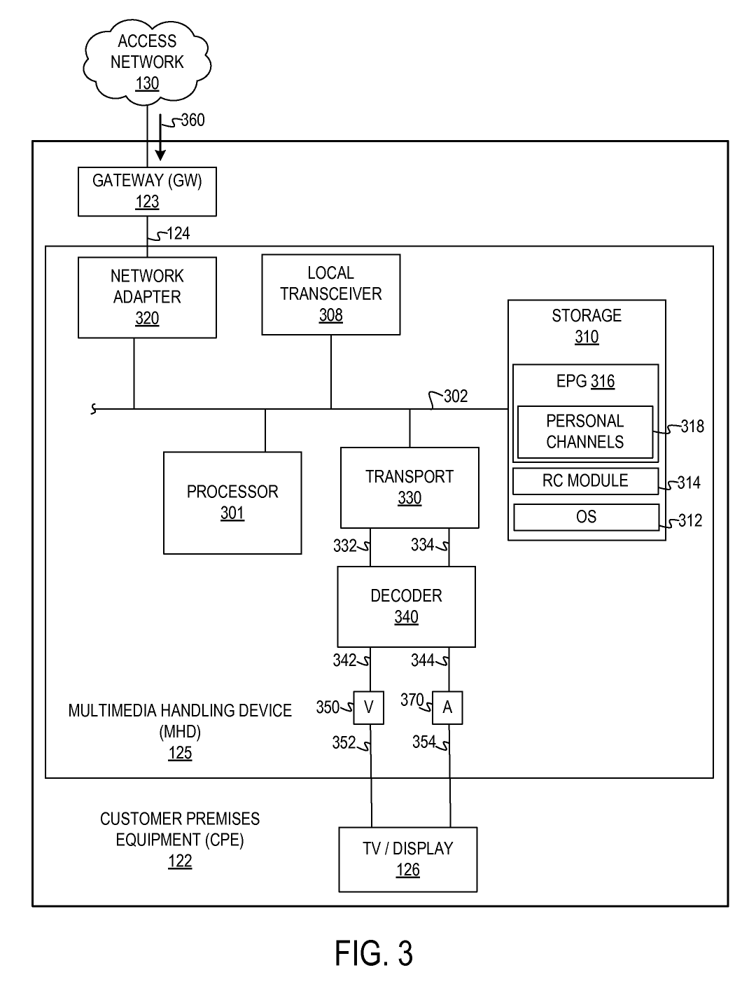

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG), such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPGs, digital video recording (DVR) services, VOD programs, PPV programs, IPTV portals, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. Application server 150 may be configured to include personal channel application 152 and authentication gateway 154, which, as will be described in detail below, may provide certain functionality for enabling an IPTV user to maintain personal IPTV channel lists.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120. Database server 190 may also store device information, such as identifiers for client 120, and details for network equipment in switching network 140 and/or backbone network 170. As shown in FIG. 1, database server 190 may include personal channel list database 192, which may store information describing personal channel lists that are respectively indexed to a plurality of individual IPTV users.

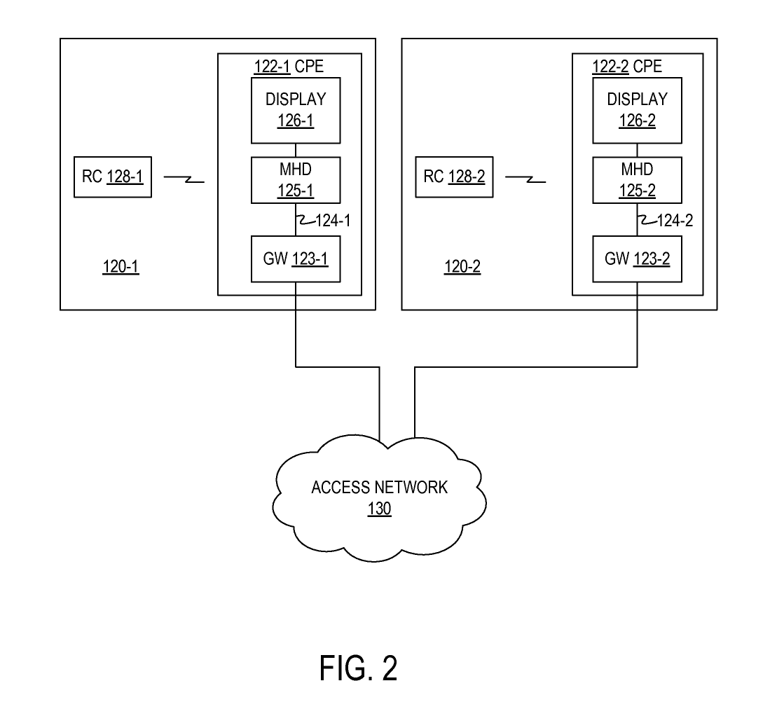

Turning now to FIG. 2, clients 120 are shown in additional detail with respect to access network 130. Clients 120 may include network appliances collectively referred to herein as customer premises equipment (CPE) 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125. In particular, remote control 128 may be used to select programs for viewing using MHD 125 and display 126.

MHD 125 is enabled and configured to process incoming multimedia signals to produce audio and visual signals suitable for delivery to display 126 and any optional external speakers (not depicted in FIG. 2). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a coaxial or IP-based multimedia content delivery network.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP-based content delivery networks, MHD 125, as depicted in FIG. 3, may include transport unit 330 that assembles the payloads from a sequence or set of network packets into a stream of multimedia content. In coaxial-based access networks, content may be delivered as a stream that is not packet-based and it may not be necessary in these embodiments to include transport unit 330. In a coaxial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 370 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown may include sets or sequences of instructions, namely, an operating system 312, a remote control application program identified as RC module 314, and EPG 316. EPG 316 may further include (or provide access to) personal channels 318, which may represent content or a user interface for maintaining personal channel lists specific to IPTV users. In some embodiments, personal channels 318 represents content (or services) provided by personal channel application 152 executing on application server 150 (see FIG. 1). Operating system 312 may be a UNIX or UNIX-like operating system, a Windows® family operating system, or another suitable operating system. In various embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In certain embodiments, an IPTV user may access personal channels 318 using remote control 128 to select elements and functions provided within the context of EPG 316.

Local transceiver 308 represents an interface of MHD 125 for communicating with external devices, such as remote control 128, or another universal remote control (URC) device. Local transceiver 308 may provide a mechanical interface for coupling to an external device, such as a plug, socket, or other proximal adapter. In some cases, local transceiver 308 is a wireless transceiver, configured to send and receive IR or RF or other signals. Local transceiver 308 may be accessed by RC module 314 for providing remote control functionality.

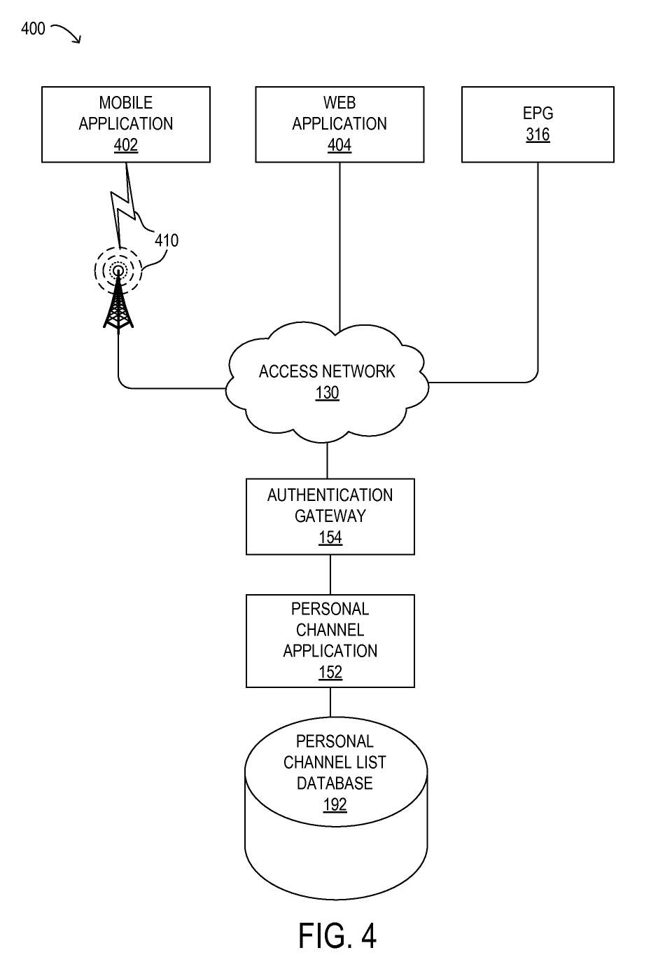

Turning now to FIG. 4, a block diagram of selected elements of an embodiment of IPTV system 400 is illustrated. It is noted that like numbered elements in FIG. 4 represent components discussed above with respect to FIGS. 1-3. IPTV system 400 depicts an exemplary combination of elements that may be configured to enable IPTV users to maintain personal channel lists, as described herein.

In IPTV system 400, access network 130 represents an interface between IPTV users and an IPTV service provider (see also FIG. 1). Access network 130 may provide a variety of options for connectivity for IPTV users. As shown in IPTV system 400, access network 130 may be accessible from mobile application 402 via wireless network 410. It is noted that wireless network 410 may represent an analog or digital wireless network. It is further noted that wireless network 410 may represent either a LAN or a wide-area network (WAN), such as a wireless telephone network. Accordingly, mobile application 402 may be executed by IPTV user using a mobile device (not shown in FIG. 4) configured for service with wireless network 410 in a number of embodiments. Access network 130 may further be accessible via web application 404, which may be executed from a web browser. Web application 404 may interact with access network 410 via a private network, or a public network, such as the Internet. In certain embodiments, web application 404 may be executed on a mobile device and connect to access network 130 via wireless network 410 (not shown in FIG. 4). Also shown in IPTV system 400, access network 130 may be configured to support EPG 316 on CPE 122 (see FIG. 3).

In operation of IPTV system 400, an IPTV user may send a request, via access network 130, to launch personal channel application 152. Prior to accessing personal channel application 152, authentication gateway 154 may authenticate an identity of the IPTV user. The authentication by authentication gateway 154 may rely upon an IPTV service account for the IPTV user, or other form of registration of the IPTV user with service provider 121 (see FIG. 1). Once the IPTV user has been authenticated, authentication gateway 154 may allow the IPTV user to access personal channel application 152 to create and maintain personal channel lists specific to the IPTV user. Personal channel application 152 may use personal channel list database 192 to store personal channel lists for a plurality of individual IPTV users. Personal channel list database 192 may accordingly store personal channel lists indexed to individual IPTV users.

It is noted that IPTV system 400 may be configured to provide personal channel lists, and related services, to a large plurality of IPTV users. For example, personal channel application 152 may represent executable instructions that may be accessed concurrently by a plurality of IPTV users, each of which may execute their own instance of personal channel application 152. In certain embodiments, personal channel application 152 may be a hosted application on a web server.

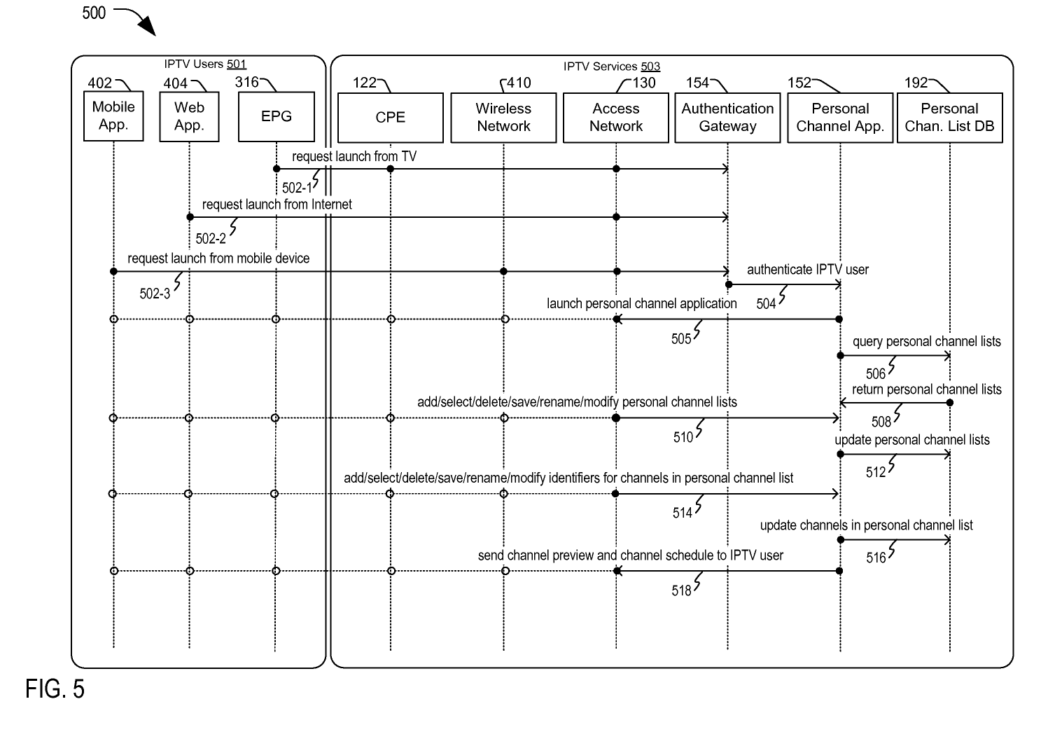

Referring to FIG. 5, a ladder diagram of an embodiment of method 500 for accessing personal channel lists over an IPTV network is shown. It is noted that like numbered elements in FIG. 5 represent components discussed above with respect to FIGS. 1-4. Method 500 includes various operations which are shown in various stages of execution. It is noted that, in FIG. 5, solid lines and filled circles represent specific interactions, while dotted lines and open circles represent one of a number of optional interactions.

In method 500, IPTV users 501 represents corresponding connectivity options for IPTV users depicted in FIG. 3, namely, mobile application 402, web application 404, and EPG 316. IPTV services 503 represents functionality and infrastructure that may be provided by service provider 121 (see FIG. 1).

In method 500, IPTV users 501 may request launching of personal channel application 152 (operation 502). An IPTV user at CPE 122 may request launching of personal channel application 152 from EPG 316 from a television device (operation 502-1). The IPTV user may use a remote control device to operate EPG 316, which may connect to access network 130 via CPE 122. An IPTV user may request launching of personal channel application 152 from web application 404 (operation 502-2). Web application 404 may be executed from a web browser and may be configured to connect to access network 130. An IPTV user may request launching of personal channel application 152 from mobile application 402 (operation 502-3). Mobile application 402 may be executed from a mobile device, such as a mobile telephone device (not shown in FIG. 5). Upon receiving a request to launch personal channel application 152, access network 130 may route the request to authentication gateway 154. Authentication gateway 154 may then authenticate the IPTV user (operation 504). When the IPTV user is not authenticated, method 500 may terminate at operation 504. When the IPTV user is authenticated, then personal channel application 152 may be launched, via access network 130, to any one of a respective connectivity option used by IPTV users 501 (operation 505). Personal channel application 152 may then query personal lists for the IPTV user from personal channel list database 192 (operation 506). If available, the query may return personal channel lists for the IPTV user from personal channel list database 192 (operation 508). If no personal channel lists are available for the IPTV user, operation 508 may return an empty personal channel list, or may indicate that no personal channel list has yet been created for the IPTV user. User input may be received from a respective connection option from the IPTV user for various operations on personal channel lists (operation 510). The personal channel list operations may include: creating a new personal channel list, deleting an existing personal channel list, selecting an existing personal channel list, adding an IPTV user to a personal channel list, adding a personal channel list, saving a personal channel list, and/or otherwise modifying a personal channel list. Modifying the personal channel list may further include naming or renaming a personal channel list, and/or adding a security element for accessing a personal channel list. A security element may be a password, or other means, to establish an identity of a user accessing the personal channel list. The personal channel lists may be updated to reflect the operations performed by the IPTV user (operation 512). Updating may include saving personal channel list information on personal channel list database 192.

Further in method 500, additional user input may be received from respective connection options from the IPTV user for various operations involving IPTV channels associated with personal channel lists (operation 514). The IPTV channel operations for personal channel lists may include: adding an indication of an IPTV channel to a personal channel list, selecting an IPTV channel included in a personal channel list, deleting an indication of an IPTV channel from a personal channel list, naming or renaming a displayed indication of an IPTV channel in a personal channel list, transferring a selected IPTV channel from one personal list to another personal list, duplicating a selected IPTV channel from one personal list to another personal list, saving IPTV channel indications included in a personal channel list, and/or otherwise modifying IPTV channel indications included in a personal channel list. The IPTV channels included in a personal channel list may be updated to reflect the operations performed by the IPTV user (operation 516).

Then, in method 500, channel preview and channel schedule information may be sent to the IPTV user via a respective connection option (operation 518). Sending preview information may include sending a preview of content currently being streamed to an IPTV channel. The preview may be in the form of a picture-in-picture video. Previews for a number of IPTV channels included in a personal channel list may be sent simultaneously to the IPTV user. The channel schedule information may include a programming guide of content scheduled for programming on an IPTV channel. The IPTV user may further select a certain IPTV channel from the preview and/or the schedule information, thereby causing the selected IPTV channel to be streamed to the IPTV user.

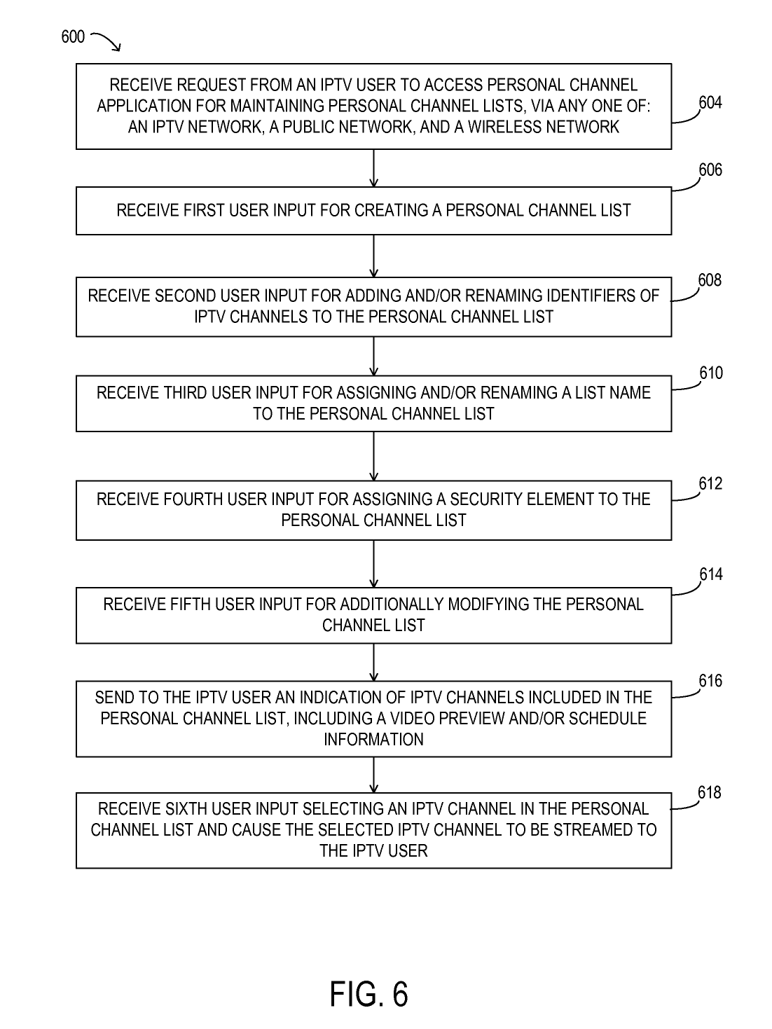

Turning now to FIG. 6, an embodiment of method 600 for maintaining personal channel lists of IPTV channels is illustrated in flow chart form. In one embodiment, method 600 may be performed by personal channel application 152 in conjunction with personal list database 192 (see FIGS. 1, 4). Method 600 may also involve functionality provided by EPG 316, personal channels 318, switching network 140, access network 130 and CPE 122. It is noted that certain operations described in method 600 may be optional or may be rearranged in different embodiments.

In method 600, a request to access a personal channel application for maintaining personal channel lists may be received from an IPTV user via any one of: an IPTV network, a public network, and a wireless network (operation 604). The public network may be the Internet. The wireless network may be a cellular telephone network. The personal channel lists may be specific to the IPTV user. First user input may be received for creating a personal channel list (operation 606). The first user input may include a name or designation for a personal channel list. Second user input may be received for adding identifiers of IPTV channels to the personal channel list (operation 608). Third user input may be received for assigning a list name to the personal channel list (operation 610). Fourth user input may be received for assigning a security element to the personal channel list (operation 612). Fifth user input may be received for additionally modifying the personal channel list (operation 614). Modifying the personal channel list may include any of a number of changes to the personal channel list or indications of IPTV channels included in the personal channel list, as described herein. An indication of IPTV channels included in the personal channel list may be sent to the IPTV user, including a video preview and/or schedule information (operation 616). Sixth user input may be received for selecting an IPTV channel in the personal channel list and the selected IPTV channel may be streamed to the IPTV user (operation 618).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for maintaining personal Internet-protocol television (IPTV) channel lists, comprising:
receiving, via an access network, a request from an IPTV user to generate a personal channel list of IPTV channels, the personal channel list being specific to the IPTV user;
in response to receiving first input from the IPTV user, creating the personal channel list for the IPTV user;
in response to receiving second input from the IPTV user, associating the second input with a corresponding IPTV channel to include in the personal channel list;
inserting an identifier for the IPTV channel in the personal channel list; and
displaying an indication to the IPTV user of IPTV channels included in the personal channel list.

2. The method of claim 1, further comprising:
storing information describing the personal channel list at a database server, wherein the information is indexed to the IPTV user, and wherein the database server includes personal channel list information indexed to a plurality of IPTV users.

3. The method of claim 2, wherein the access network comprises a portion of at least one of: an IPTV network, a public network, an Internet network, and a wireless network, and further wherein, the personal channel list information is accessible from at least one of: any of a plurality of customer premises equipment and a mobile device.

4. The method of claim 1, further comprising:
in response to receiving the request, authenticating an identity of the IPTV user based on an IPTV network account for the IPTV user.

5. The method of claim 1, further comprising:
in response to receiving third user input from the IPTV user, assigning a list name to the personal channel list.

6. The method of claim 1, further comprising:
in response to receiving fourth user input from the IPTV user, assigning a security element for restricting access to the personal channel list.

7. The method of claim 1, wherein the displayed indication further includes:
a video preview of content currently being transmitted to IPTV channels in the personal channel list; and
schedule information for IPTV channels in the personal channel list.

8. A computer system for enabling Internet-protocol television (IPTV) users to access personal channel lists, comprising:
a processor configured to access to memory media,
wherein the memory media include instructions executable by the processor to:
receive, via an access network, a request from an IPTV user to access a personal channel list of IPTV channels, the personal channel list being specific to the IPTV user; and
cause an indication to be displayed to the IPTV user of IPTV channels included in the personal channel list.

9. The computer system of claim 8, wherein the memory media further include instructions executable by the processor to:
in response to receiving first input from the IPTV user, create the personal channel list for the IPTV user;
in response to receiving second input from the IPTV user, associate the second input with a corresponding IPTV channel to include in the personal channel list; and
store an identifier for the selected IPTV channel in the personal channel list.

10. The computer system of claim 8, wherein the memory media further include instructions executable by the processor to:
in response to receiving third input from the IPTV user selecting an IPTV channel included in the personal channel list, display the selected IPTV channel for viewing.

11. The computer system of claim 8, wherein the memory media further include instructions executable by the processor to:
in response to receiving fourth input from the IPTV user, modify the personal channel list, including processor instructions to execute at least one of: add an IPTV channel identifier to the personal channel list, remove an IPTV channel identifier from the personal channel list, rename the personal channel list, rename an IPTV channel identifier included in the personal channel list, and delete the personal channel list.

12. The computer system of claim 8, wherein the memory media further include instructions executable by the processor to:
in response to receiving the request, authenticate an identity of the IPTV user; and
store information describing the personal channel list in a database indexed to the IPTV user identity, wherein the database includes personal channel list information indexed to a plurality of IPTV users.

13. The computer system of claim 8, wherein the access network comprises a portion of at least one of: an IPTV network, a public network, an Internet network, and a wireless network, and wherein said displayed indication is sent to the IPTV user via the access network.

14. Computer-readable memory media, including for enabling Internet-protocol television (IPTV) users to maintain personal channel lists, instructions executable to:
receive, via an access network, a request from an IPTV user to access a personal channel list of IPTV channels, the personal channel list being specific to the IPTV user; and
send to the IPTV user, via the access network, an indication of IPTV channels included in the personal channel list.

15. The memory media of claim 14, further including instructions executable to:
in response to receiving first input from the IPTV user, create the personal channel list for the IPTV user;
in response to receiving second input from the IPTV user, select an IPTV channel to include in the personal channel list; and
store an identifier for the selected IPTV channel in the personal channel list.

16. The memory media of claim 14, further including instructions executable to:
in response to receiving the request, authenticate an identity of the IPTV user; and
store information describing the personal channel list in a database indexed to the IPTV user identity, wherein the database includes personal channel list information indexed to a plurality of IPTV users.

17. The memory media of claim 14, wherein the access network comprises a portion of at least one of: an IPTV network, a public network, an Internet network, and a wireless network.

18. The memory media of claim 14, further including instructions executable to:
in response to receiving first input from the IPTV user, modify the personal channel list, including at least one of: add an IPTV channel identifier to the personal channel list, remove an IPTV channel identifier from the personal channel list, delete the personal channel list, assign a security element for restricting access to the personal channel list, assign a list name to the personal channel list, rename the personal channel list, and rename an IPTV channel identifier.

19. The memory media of claim 14, further including instructions executable to:
in response to receiving second input from the IPTV user selecting an IPTV channel included in the personal channel list, display the selected IPTV channel for viewing.

20. The memory media of claim 14, wherein the indication sent to the IPTV user further includes:
a video preview of content currently being transmitted on the IPTV channels in the personal channel list; and
schedule information for IPTV channels in the personal channel list.
